(19) United States
(12) Patent Application Publication
(10) Pub. No.: US 2026/0046891 A1
(43) Pub. Date: Feb. 12, 2026

(54) METHODS OF COMMUNICATION, TERMINAL DEVICE, NETWORK DEVICE AND COMPUTER STORAGE MEDIUM

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 19/100,665

(22) PCT Filed: Aug. 9, 2022
(86) PCT No.: PCT/CN2022/111278

§ 371 Date: Feb. 3, 2025

(51) Int. Cl. H04W 72/232

(52) U.S. Cl. CPC H04W 72/232

(57) ABSTRACT

Embodiments of the present disclosure relate to methods of communication, terminal device, network device, and computer readable media. A terminal device receives downlink control information from the network device, with the downlink control information including a field used for indicating a set of PDCCH monitoring behaviors. The terminal device performs the set of PDCCH monitoring behaviors on at least one cells or at least one cell groups of plurality of cells based on the field. In this way, power saving effect can be enhanced.

### TECHNICAL FIELD

Embodiments of the present disclosure generally relate to the field of telecommunication, and in particular, to methods of communication, a terminal device, a network device and a computer storage medium.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

Wireless communication networks may use discontinuous reception (DRX) modes to communicate with certain terminal devices for applications that do not require continuous reception, for example, for Extended Reality enhancement. DRX may provide various advantages, for example power conservation in terminal devices. Notwithstanding these advantages, DRX modes as presently implemented may not produce optimal power conservation outcome. And In NR release 18, power saving for XR services is one of the three objectives (i.e., XR awareness scheduling, power saving and capacity enhancement) of this study. It would be desirable, therefore, to provide improved methods for power saving in a wireless communications system.

### SUMMARY

In general, embodiments of the present disclosure provide a solution for improved PDCCH monitoring adaptation.

In a first aspect, there is provided a method of communication. The method comprises: receiving, at a terminal device from a network device, downlink control information (DCI) including a field indicating a set of physical downlink control channel (PDCCH) monitoring behaviors, the field including one of the following: a plurality of bit sub-groups for a plurality of cells, or a bit group applied to the plurality of cells; and performing the set of PDCCH monitoring behaviors on at least one cells of a set of cells or at least one cell groups of a set of cell groups based on the field.

In a second aspect, there is provided a method of communication. The method comprises: determining, at a terminal device, to skip PDCCH monitoring on a first cell of a set of cells; receiving, from a network device, first DCI in a second cell of the set of cells; and resuming the PDCCH monitoring on the first cell in response to receiving the first DCI in the second cell.

In a third aspect, there is provided a method of communication. The method comprises: determining, at a terminal device, to skip PDCCH monitoring on a cell of a set of cells; and resuming the PDCCH monitoring on the cell based on an indication from a higher layer of the terminal device.

In a fourth aspect, there is provided method of communication. The method comprises: determining, at a terminal device, to skip PDCCH monitoring on a cell of a set of cells; and resuming the PDCCH monitoring on the cell at a starting time of a DRX cycle or an on-duration timer or at the time of the starting time of the DRX cycle or the on-duration timer plus a time offset.

In a fifth aspect, there is provided method of communication. The method comprises: determining, at a terminal device, to skip PDCCH monitoring on a cell of a set of cells; and resuming the PDCCH monitoring on the cell at a starting time of a jitter boundary or at the time of the starting time of the jitter boundary plus a time offset.

In a sixth aspect, there is provided method of communication. The method of communication comprises: generating, at a network device, DCI including a field indicating a set of PDCCH monitoring behaviors, the field including one of the following: a plurality of bit sub-groups for a plurality of cells, or a bit group applied to the plurality of cells; and transmitting the DCI to a terminal device.

In a seventh aspect, there is provided method of communication. The method of communication comprises: transmitting, at a network device to a terminal device, an indication of skipping PDCCH monitoring on a first cell of a set of cells; determining that the PDCCH monitoring by the terminal device on the first cell is to be resumed; and transmitting, to the terminal device, first DCI for a second cell of the set of cells.

In an eighth aspect, there is provided a terminal device. The terminal device comprises a processor and a memory coupled to the processor and storing instructions thereon. The instructions, when executed by the processor, cause the terminal device to perform the method according to the first, second, third, fourth or fifth aspect of the present disclosure.

In a ninth aspect, there is provided a network device. The network device comprises a processor and a memory coupled to the processor and storing instructions thereon. The instructions, when executed by the processor, cause the network device to perform the method according to the sixth or seventh aspect of the present disclosure.

In a tenth aspect, there is provided a computer readable medium having instructions stored thereon. The instructions, when executed on at least one processor, cause the at least one processor to perform the method according to the first, second, third, fourth or fifth aspect of the present disclosure or the method according to the sixth or seventh aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a schematic diagram of an example communication network in which some embodiments of the present disclosure can be implemented;

FIG. 2 illustrates a signaling chart illustrating an example process of communication implemented in accordance with some embodiments of the present disclosure:

FIG. 3 illustrates a schematic diagram of an example method of communication implemented in accordance with some embodiments of the present disclosure:

FIG. 4 illustrates a signaling chart illustrating another example process of communication implemented in accordance with some embodiments of the present disclosure;

FIG. 5a illustrates a schematic diagram of an example method of communication implemented in accordance with some embodiments of the present disclosure:

FIG. 5b illustrates a schematic diagram of another example method of communication implemented in accordance with some embodiments of the present disclosure:

FIG. 6 illustrates an example method of communication implemented at a terminal device in accordance with some embodiments of the present disclosure:

FIG. 7a illustrates another example method of communication implemented at a terminal device in accordance with some embodiments of the present disclosure:

FIG. 7b illustrates another example method of communication implemented at a terminal device in accordance with some embodiments of the present disclosure:

FIG. 7c illustrates another example method of communication implemented at a terminal device in accordance with some embodiments of the present disclosure:

FIG. 7d illustrates another example method of communication implemented at a terminal device in accordance with some embodiments of the present disclosure:

FIG. 8 illustrates an example method of communication implemented at a network device in accordance with some embodiments of the present disclosure:

FIG. 9 illustrates another example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The “terminal device” can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Discontinuous reception (DRX) provides a process for a terminal device (or UE) to save power by periodically entering a sleep mode and periodically waking to monitoring channels, such as Physical Downlink Control Channel (PDCCH). In NR release 17, the PDCCH monitoring adaptation mechanism is enhanced, and search space set group (SSSG) switching and PDCCH skipping are specified. This feature enables PDCCH based method for UE power saving.

However, due to the insufficient time in Rel-17, only scheduling PDCCH (i.e., DCI format 0-1, 0-2, 1-1, 1-2) were agreed to support the SSSG switching and PDCCH skipping, which is not very flexible, especially for the case that the packet arrival time is not very regular. Therefore, it is proposed in the XR enhancement SI to enhance the Rel-17 mechanism to support the non-scheduling PDCCH indicating SSSG switching and PDCCH skipping.

In NR Rel-16, the SSSG switching is introduced in the New Radio (NR) unlicensed spectrum topic. In this release, UE can be configured with two SSSGs for a specific cell, and each SSSG includes a group of search space sets. DCI format 2_0 is used to indicate one of the two groups for UE, if the indicated group is different from the group UE is currently used, UE should assume the SSSG is switched after a duration of switching gap.

In NR Rel-17, the SSSG switching mechanism is enhanced in the UE power saving topic. The supported number of SSSGs is extended to three, while PDCCH skipping is also supported. In this release, scheduling DCI is used to indicate the SSSG switching and PDCCH skipping, UE can be indicated with one of the followings by DCI format 0-1, 0-2, 1-1, or 1-2: No PDCCH skipping: PDCCH skipping for a duration (the duration can be one of a set of preconfigured durations); or an SSSG index (the index can be 0, 1 or 2).

In NR Rel-17, if a UE is provided with cellGroupsForSwitchList, indicating one or more groups of serving cells, the PDCCH monitoring adaptation should apply to all serving cells within each group if UE received an indication of the PDCCH monitoring adaptation in a serving cell belongs to the cell group.

In NR Rel-18, the PDCCH monitoring adaptation may be further enhanced in the XR power saving topic. It is beneficial that the non-scheduling DCI is used for trigging PDCCH monitoring adaptation. DCI format 1-1 may be reused for this purpose. The fields originally used for scheduling (e.g., resource allocation, HARQ number, MCS indication, etc.) in the DCI format can be reused for indication of PDCCH monitoring adaptation. Therefore, the available payload bits in the DCI format may be quite many; e.g., more than 10 bits. Considering the relatively more available bits in the DCI format, it is reasonable to also support the multi-cell indication of PDCCH monitoring adaptation. The mechanism for multi-cell indication of PDCCH monitoring adaptation should be studied and specified.

On the other hand, the existing PDCCH skipping duration can only be a certain number, e.g., 10 slots, 100 slots, etc. Considering the jitter effect of the XR packets arrival time, it is difficult to predict the accurate arrival time of next XR packet, so it is difficult to choose an appropriate number for the skipping duration. Therefore, it is necessary to study how to enhance the skipping duration to handle the jitter effect better. In view of the above, embodiments of the present disclosure provide a solution for solving the above and other potential issues. Principles and implementations of the present disclosure will be described in detail below with reference to the figures.

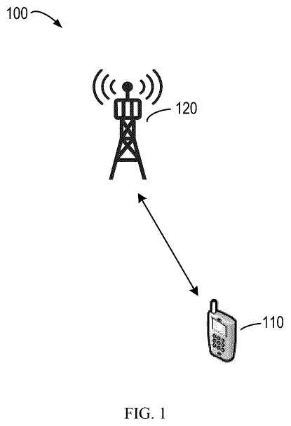

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a serving cell (also referred to as a cell herein), and the terminal device 110 may be located in the cell and may be served by the network device 120. It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 is referred to as UL communication, while communication in a reverse direction from the network device 120 towards the terminal device 110 is referred to as DL communication. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH), and a physical broadcast channel (PBCH).

In some embodiments, the terminal device 110 may transmit UL data to the network device 120 via a UL data channel transmission. For example, the UL data channel transmission may be a physical uplink shared channel (PUSCH) transmission. Of course, any other suitable forms are also feasible. In some embodiments, the terminal device 110 may receive DL data from the network device 120 via a DL data channel transmission. For example, the DL data channel transmission may be a physical downlink shared channel (PDSCH) transmission. Of course, any other suitable forms are also feasible.

In some embodiments, the terminal device 110 may receive, from the network device 120, downlink control information (DCI) via a DL control channel transmission. For example, the DL control channel transmission may be a PDCCH transmission. Of course, any other suitable forms are also feasible. In some embodiments, the terminal device 110 may transmit uplink control information (UCI), e.g., HARQ feedback information, to the network device 120 via an UL control channel transmission. For example, the UL control channel transmission may be a PUCCH transmission. Of course, any other suitable forms are also feasible.

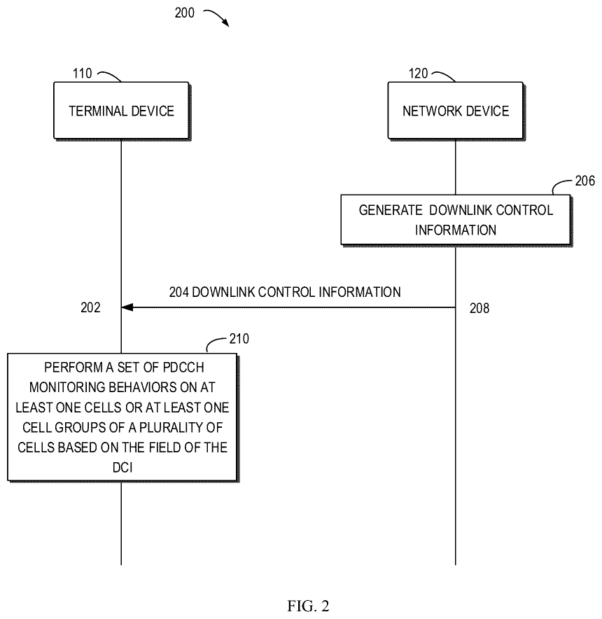

Reference is now made to FIG. 2, which shows a signaling chart illustrating process 200 of communication according to various embodiments. Only for the purpose of discussion, the process 200 will be described with reference to FIG. 1. The process 200 may involve the terminal device 110 and the network device 120 in FIG. 1.

As shown in FIG. 2, the terminal device 110 receives 202 downlink control information (DCI) 204 from the network device 120, with the DCI 204 including a field used for indicating a set of PDCCH monitoring behaviors. The DCI is also termed as non-scheduling DCI herein, and the non-scheduling DCI can be considered as a scheduling DCI (e.g., DCI format 1-1) reused for the indication of PDCCH monitoring without scheduling a DL or UL transmission. Multi-cell PDCCH monitoring adaptation can be introduced based on a non-scheduling DCI, which is based on the legacy DCI formation. The PDCCH monitoring adaptation can be designed based on the field of DCI. In other words, if a DCI format is determined for indicating PDCCH monitoring adaptation, the UE considers the DCI format as indicating PDCCH monitoring adaptation, not scheduling a PDSCH reception or PUSCH transmission, and multiple fields for PDSCH/PUSCH scheduling are re-interpreted as a field for PDCCH monitoring adaptations.

The multiple fields for PDSCH/PUSCH scheduling may comprise at least one of the following DCI fields: modulation and coding scheme: new data indicator: redundancy version; HARQ process number: antenna port(s); and DMRS sequence initialization. These fields can be reused as the field of non-scheduling DCI, and the field of non-scheduling DCI includes a plurality of bit sub-groups for a plurality of cells respectively, or a bit group applied to the plurality of cells and interpreted individually for each cell, as further described below. For example, some bits may be selected from at least one of the DCI fields as described above, and the some bits may be combined into the field of DCI 204 as a bitmap. As an example, 2 bits may be selected from the new data indicator with 4 bits, and 3 bits may be selected from the redundancy version with 5 bits. Then the 2 bits and 3 bits can be reused as the field of DCI 204. As another example, 4 or 5 bits may be selected from the redundancy version with 5 bits. Then the 4 or 5 bits can be reused as the field of DCI 204. As another example, 3 bits may be selected from the new data indicator with 4 bits, 4 bits may be selected from the redundancy version with 5 bits, and 1 bit may be selected from the HARQ process number with 1 bit. Then the 2 bits, 3 bits and 1 bit can be reused as the field of DCI 204. Alternatively, a group-common PDCCH, e.g., DCI format 2-0) or DCI format 2-6, or a scheduling DCI with valid PDSCH/PUSCH assignment, can also be used to indicate the PDCCH monitoring adaptation.

On the other side of communication, the network device 120 generates 206 the DCI 204 including a field indicating a set of PDCCH monitoring behaviors. The field of the DCI includes a plurality of bit sub-groups for a plurality of cells respectively, or a bit group applied to the plurality of cells and interpreted individually for each cell, as further described below: Then, the network device 120 transmits 208 the DCI 204 to the terminal device 110.

In some embodiments, the set of PDCCH monitoring behaviors may comprise a plurality of PDCCH monitoring behaviors, such as no PDCCH skipping and/or no PDCCH switching: skipping PDCCH monitoring for a duration; starting PDCCH monitoring with a search space set group (SSSG) index, and stopping PDCCH monitoring with another SSSG index; skipping PDCCH monitoring without indicating a duration (in other words, pausing the PDCCH monitoring); terminating a PDCCH monitoring skipping (in other words, resuming the PDCCH monitoring); or any combination thereof.

It should be understood that the behavior of skipping PDCCH monitoring without indicating a duration may include the behavior of skipping PDCCH monitoring without a duration value indicated for the PDCCH monitoring skipping. Alternatively, the behavior of skipping PDCCH monitoring without indicating a duration may include the behavior of skipping PDCCH monitoring with a non-numerical value (e.g., a negative integer, or a logical value “NA” which is invalid for a time duration) indicated for the PDCCH monitoring skipping.

The plurality of cells may include (or be) a set of cells or a set of cell groups here. The set of PDCCH monitoring behaviors may correspond to (subset of) the set of cells, and the set of PDCCH monitoring behaviors may be indicated to (subset of) the set of cells. Optionally, the set of PDCCH monitoring behaviors may correspond to (subset of) the set of cell groups, and the set of PDCCH monitoring behaviors may be indicated to (subset of) the set of cell groups.

With the received DCI, the terminal device 110 performs 210 the set of PDCCH monitoring behaviors on at least one cells or at least one cell groups of a plurality of cells based on the field. It should be understood that the at least one cells may be all of cells included in the plurality of cells, or may be a portion of cells included in the plurality of cells. Similarly, the at least one cell groups may be all of cell groups included in the plurality of cells, or may be a portion of cell groups included in the plurality of cells.

For example, the terminal device 110 performs “PDCCH monitoring skipping without indicating a duration” on a cell in the set of cells or a cell group of the set of cell groups, and/or performs “PDCCH monitoring skipping for a duration” on another cell in the set of cells or another cell group in the set of cell groups, and/or does not perform any behavior on the other cell in the set of cells or the other cell group in the set of cell groups. It is to be understood that the behavior indicated to a cell or a cell group may be same as, or different from the behavior indicated to another cell or another cell group.

Embodiments of the disclosure provide an improved method for multi-cell PDCCH monitoring adaptation, which enhances the flexibility of PDCCH monitoring, i.e., the PDCCH monitoring behavior can be adjusted in a per-cell manner, therefore power saving effect can be enhanced. Further, if a non-scheduling DCI is used for indication of multi-cell PDCCH monitoring adaptation, e.g., reusing the DCI format 1-1, there will be sufficient available bits for the indication, therefore, multi-cell indication can be supported without increasing the DCI size.

For example, a cell of multiple cells is associated with a DCI field of a DCI format. The DCI field is used to indicate a set of behaviors. UE can be configured with a DCI format, and the DCI format comprises at least one DCI field, and a DCI field of the at least one DCI filed is used to indicate a behavior from a set of behaviors for at least one cell or at least one cell group. When a single DCI field is used to indicate behaviors of multiple cells or multiple cell groups (i.e., the multiple cells or multiple cell groups are associated with a same DCI field), the interpretation of the DCI field can be different for different cells or cell groups, i.e., a value of the DCI field is associated with different behaviors for different cells. As such, the disclosure provides a method of independent indication for each of multiple cells.

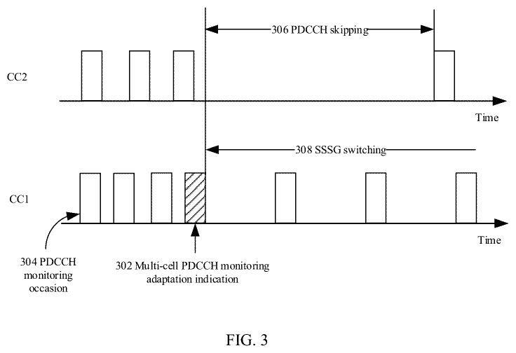

As shown in FIG. 3, a UE can be configured with multiple cells (for example cell 1 and cell2), and each cell is configured with a set of SSSGs and/or a set of skipping durations. The monitoring of PDCCH 1 in a cell (for example cell 1) operating in Component Carrier 1 (i.e., CC1) and PDCCH 2 in a cell (for example cell 2) operating in Component Carrier 2 (i.e., CC2) is shown in FIG. 3. When multi-cell PDCCH monitoring adaptation indication 302 is received at certain PDCCH monitoring occasion 304, a PDCCH monitoring behavior, such as PDCCH skipping 306 or SSSG switching 308, may be performed on a cell (for example cell 1 or cell 2).

In some embodiments, the field includes a bit group applied to the plurality of cells. A value for the bit group can indicate a PDCCH monitoring behavior for a cell in a set of cells or a cell group in a set of cell groups. The set of cells may comprise multiple cells. The set of cell group may comprise multiple cell groups. For example, as shown in Table 1, the value v0 for the bit group indicates Behavior 0-0 (e.g. skipping PDCCH monitoring without indicating a duration) for cell 0 or cell group 0, the value v0 for the bit group indicates Behavior 1-0 (e.g. skipping PDCCH monitoring without indicating a duration) for cell 1 or cell group 1, and so on. It is to be understood that the Behavior 0-0 may be same as, or different from the Behavior 1-0.

TABLE 1
A bit group indicates behaviors of k cells or
cell groups with independent interpretation

| | Behavior set | Behavior set | | Behavior set |
|---|---|---|---|---|
| Value of | for cell 0 or | for cell 1 or | | for cell k or |
| the field | cell group0 | cell groups 1 | . . . | cell groups k |
| v0 | Behavior 0-0 | Behavior 1-0 | . . . | Behavior k-0 |
| v1 | Behavior 0-1 | Behavior 1-1 | . . . | Behavior k-1 |
| . . . | . . . | . . . | . . . | . . . |

In other embodiments, a value for the bit group does not indicate any PDCCH monitoring behavior for a cell in a set of cells or a cell group in a set of cell groups. For example, as shown in Table 2, the value v0 for the bit group indicates Behavior 0-0 (e.g. skipping PDCCH monitoring without indicating a duration) for cell 0 or cell group 0, but does not indicate any behavior for cell 1 or cell group 1, and so on. Therefore, the value v0 can be indicates behaviors for a subset of cells or a subset of cell groups. The subset of cells can be determined from the set of cells according to the value v0, the subset of cell groups can be determined from the set of cell groups according to the value v0. Other values for the field are similar as the value v0, and not repeatedly described herein for the sake of brevity.

TABLE 2
A bit group indicates behaviors of k cells or cell
groups based on a behavior list of multiple cells

| Value of | | | | |
|---|---|---|---|---|
| the field | Behaviors for the k cells or k cell groups | | | |
| v0 | Behavior 0-0 | Not indicated | . . . | Behavior k-0 |
| | for cell 0 or | | | for cell k or |
| | cell group 0 | | | cell group k |
| v1 | Not indicated | Behavior 1-0 | . . . | Behavior k-1 |
| | | for cell 1 or | | for cell k or |
| | | cell group 1 | | cell group k |
| . . . | . . . | . . . | . . . | . . . |

In some embodiments, the field includes a plurality of bit sub-groups for a plurality of cells. A value for a bit sub-group can indicate a PDCCH monitoring behavior for a cell in a set of cells or a cell group in a set of cell groups, and a value for another bit sub-group can indicate a PDCCH monitoring behavior for another cell in the set of cells or another cell group in the set of cell groups. For example, as shown in Table 3, the value v0 for the bit sub-group 0 indicates Behavior 0-0 (e.g. skipping PDCCH monitoring without indicating a duration) for cell 0 or cell group 0, the value v0 for the bit sub-group k indicates Behavior k-0 (e.g. skipping PDCCH monitoring without indicating a duration) for cell k or cell group k, and so on. It is to be understood that the Behavior 0-0 may be same as, or different from the Behavior k-0.

TABLE 3
k bit sub-groups indicate behaviors of
k cells or cell groups independently

| Bit | Value of the | |
|---|---|---|
| sub-group | bit sub-group | Behavior |
| 0 | v0 | Behavior 0-0 for |
| | | cell 0 or cell |
| | | group 0 |
| | v1 | Behavior 0-1 for |
| | | cell 0 or cell |
| | | group 0 |
| | . . . | . . . |
| . . . | . . . | . . . |
| k | v0 | Behavior k-0 for |
| | | cell k or cell |
| | | group k |
| | v1 | Behavior k-1 for |
| | | cell k or cell |
| | | group k |
| | . . . | . . . |

For example, for the field for PDCCH monitoring adaptation in the DCI field, there are two options. With respect to option one, as shown in table 3 (k bit sub-groups indicate behaviors of k cells or cell groups independently), the field is divided into multiple bit sub-group (note: the term bit sub-group is same as the DCI field above), and the i^{th} bit sub-group comprise Ni bits, where i and Ni are integers not smaller than 0. Each bit sub-group is associated with one or more cells, or one or more cell groups. It is used to indicate the behavior of PDCCH monitoring for the one or more cells, or one or more cell groups. Optionally, values of Ni are same for different i. Alternatively, values of Ni are different for different i.

With respect to option two, all the cells and cell groups are associated with the single DCI field, and two sub-option methods can be used. In sub-option one, as shown in table 1 (a bit group indicates behaviors of k cells or cell groups with independent interpretation), the field is interpreted independently for each cell or cell group. This means that a value of the field may indicate different behaviors for different cells or cell groups. In sub-option two, as shown in table 2 (a bit group indicates behaviors of k cells or cell groups based on a behavior list of multiple cells), the field indicates a row of a behavior table. And each row of the behavior table comprises the behaviors of at least one of the k cells or cell groups. Optionally, for a certain row of the table, a behavior of a certain cell or cell group may be not indicated.

Optionally, assuming k cells or cell groups are associated with the DCI format, for a specific time slot, the network may only want to change the PDCCH monitoring behavior of a subset of the k cells or cell groups. For clarity, in this embodiment, the subset of the k cells can be considered as the at least one cells as described above, and the subset of the k cell groups can be considered as the at least one cell groups as described above. Therefore, when UE receive a DCI, UE may need to determine a subset of the k cells or cell groups which is indicated by the DCI (and the other cells or cell groups not indicated by the DCI may keep their PDCCH monitoring behaviors).

In one example, the subset, which comprises at least one cells of a set of cells or at least one cell groups of a set of cell groups, may be determined by a row of a table 2 associated with the bit group. For example, referring to sub-option two. gNB may configure a behavior table through RRC signaling, each row of the table indicates PDCCH monitoring behaviors of multiple cells or cell groups. Specifically; a row of the behavior table (in other words, an index of a list of multi-cell PDCCH monitoring behaviors) is associated with multiple cell indices or cell group indices (i.e., the subset of the k cells or cell groups), and each of the multiple cell indices or cell group indices is associated with a PDCCH monitoring behavior. In addition, the cell indices or the cell group indices associated with different rows can be different.

In another example, the subset may be determined by a carrier indication field, which may be included in the DCI or may be included in the field of DCI. For example, the DCI format includes a carrier indication field, e.g., a bit map of k bits, this field indicates whether a cell or cell group is indicated with a PDCCH monitoring behavior. Optionally, this carrier indication field may also be used for other purpose, e.g., to indicate the scheduling cells (in this case, the DCI format is also be used for multi-cell scheduling), to indicate the dormant cells, etc.

In yet another example, the subset may be determined by the difference between a preconfigured value and a received value for the bit group or a value for a bit sub-group. For example, a reserved or preconfigured value is configured for the field or bit sub-group associated with a cell or a cell group, if the value of the DCI is equals to the reserved or preconfigured value, UE may determines that it does not indicate to change the behavior of the PDCCH monitoring.

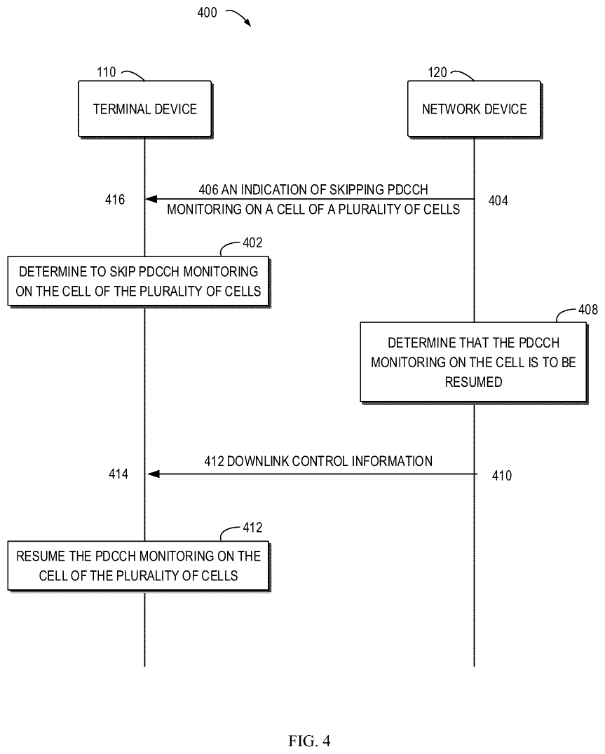

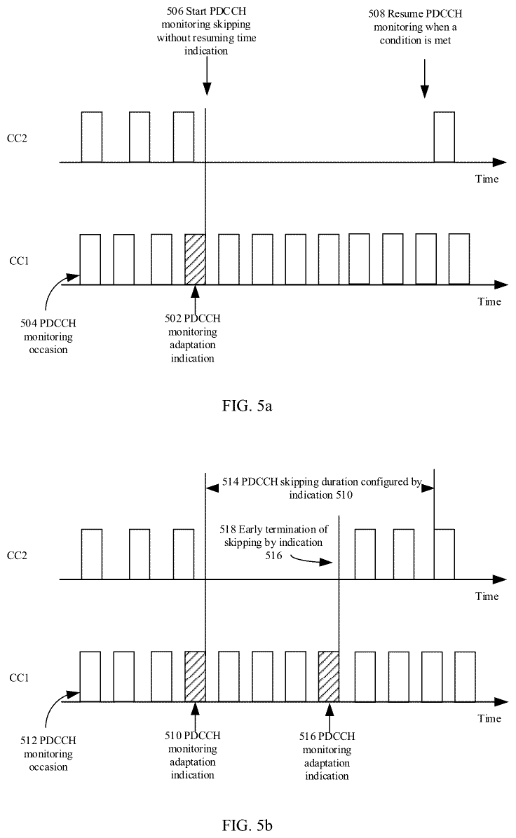

With the PDCCH skipping mechanism, when the transmission of a traffic packet is finished, UE can be indicated to skip the upcoming PDCCH occasions and resume the PDCCH monitoring before the arrival of the next traffic packet. However, due to the unpredicted arrival time caused by the jitter, it is difficult to determine an accurate arrival time of the next traffic packet, therefore the skipping duration cannot be configured accurately: In view of this, some embodiments of the present disclosure provide an improved solution of resuming PDCCH monitoring. The solution will be described in detail with reference to FIGS. 4, 5a and 5b below.

Reference is now made to FIG. 4, which shows a signaling chart illustrating process 400 of communication according to various embodiments. Only for the purpose of discussion, the process 400 will be described with reference to FIG. 1. The process 400 may involve the terminal device 110 and the network device 120 in FIG. 1. The same reference numerals are used to denote the steps or components described in FIG. 4 having the same operations as the steps or components described in FIG. 2, and detailed description thereof will be omitted. It is to be understood that the steps and the order of the steps in FIG. 4 are merely for illustration, and not for limitation. For example, the order of the steps may be changed. Some of the steps may be omitted or any other suitable additional steps may be added.

As shown in FIG. 4, the terminal device 110 determines 402 to skip PDCCH monitoring on a cell of a plurality of cells. For example, in the scenario that the required data rate become lower and the scheduling in multiple cells may be not needed temporally, UE receives 416, from the network device 120, an indication of skipping PDCCH monitoring without indicating duration, and determines to skip the PDCCH monitoring based on this indication. Alternatively, in the scenario that the network does know the exactly arrival time of next traffic packet, UE receives 416, from the network device 120, an indication of skipping PDCCH monitoring for duration Tc, and determines to skip the PDCCH monitoring based on this indication. Note that this can be applied for single cell PDCCH monitoring adaptation as well.

On the other side of communication, the network device 120 transmits 404 an indication 406 of skipping PDCCH monitoring on the cell of the plurality of cells. The indication may not indicate a duration. In some embodiments, the network device 120 may transmit 404 DCI indicating a PDCCH monitoring skipping on the cell of a plurality of cells. The network device 120 determines 408 that the PDCCH monitoring by the terminal device 110 on the cell is to be resumed, and transmits 410 DCI 412 for another cell in the plurality of cells.

When a specific condition is met or an event occurs, the UE resumes the PDCCH monitoring which previously has been skipped. For example, when the UE receives a PDCCH monitoring adaptation indication which indicates the UE to resume the PDCCH monitoring, the UE resumes the PDCCH monitoring. As shown in FIG. 4, the terminal device 110 receives 414, from the network device 120, DCI in another cell of the plurality of cells. The field of the DCI can indicate behavior(s) of terminating a PDCCH monitoring skipping as described above. Then, the terminal device 110 resumes 412 the PDCCH monitoring on the cell in response to receiving the DCI in another cell.

With the process 400, if transmission of a traffic packet is finished, the UE can be indicated to skip the coming PDCCH occasions until it received an indication on another cell which indicates it to terminate the skipping. For example, PDCCH skipping without a numerical duration can be introduced, and the skipping can be terminated based on DCI indication in another cell. Based on this mechanism, the PDCCH monitoring can be resumed as early as possible after the new packet arrived at the scheduler of network device or can be resumed as desired for specific application. The UE can stay in sleeping mode before it received the indication, therefore more power may be saved.

FIGS. 5a and 5b illustrate an example method of communication implemented at a network device in accordance with some embodiments of the present disclosure respectively. For illustrative purposes only; as example, a UE is configured with multiple cells (for example cell 1 and cell2), cell 1 is configured with a SSSG for PDCCH monitoring, and cell 2 is configured with another SSSG for PDCCH monitoring. The monitoring of PDCCH 1 in a cell (for example cell 1) operating in CC1 and PDCCH 2 in a cell (for example cell 2) operation in CC2 is shown in FIGS. 5a and 5b.

In FIG. 5a, when a PDCCH monitoring adaptation indication 502 (for example DCI 1) is received in cell 1 at certain PDCCH occasion 504, a PDCCH monitoring skipping may be started 506 in cell 2 without resuming time indication. Alternatively, when a PDCCH monitoring adaptation indication 502 (for example DCI 1) is received in cell 2 at certain PDCCH occasion 504, a PDCCH monitoring skipping may be started 506 in cell 2 without resuming time indication. Then, the UE may resume 508 the PDCCH monitoring on cell 2 when a condition is met or an event occurs.

In an example, the resuming may be based on a PDCCH monitoring adaptation indication which indicates the UE to resume the PDCCH monitoring (for example DCI 2), as stated in process 400 of FIG. 4.

In another example, the resuming may be based on an indication from a higher layer of the terminal device. For example, when UE receives a higher layer indication which indicates UE to resume the PDCCH monitoring, the UE may resume the PDCCH monitoring on cell 2. The higher layer indication may be RRC, PDCP, RLC, or MAC layer indication. The higher layer indication may be triggered based on the traffic packets arrival time, jitter, packet delay budget, etc.

In yet another example, the resuming may be implemented at a starting time of a DRX cycle or an on-duration timer or at the time of the starting time of the DRX cycle or the on-duration timer plus a time offset. For example, when a new DRX cycle or a new on-duration timer is started, or at the time of the starting time of a new DRX cycle or a new on-duration timer plus a time offset, the UE may resume the PDCCH monitoring on cell 2.

In still yet another example, the resuming may be implemented at a starting time of a jitter boundary or at the time of the starting time of the jitter boundary plus a time offset. For example, when at the starting time of a jitter boundary (i.e., the earliest time that a traffic packet may arrive (or is expected to arrive) at the UE), or at a time of the starting time of the jitter boundary plus a time offset, the UE may resume the PDCCH monitoring on cell 2. In this case, XR-awareness scheduling may be supported.

In FIG. 5b, when a PDCCH monitoring adaptation indication 510 is received in cell 1 at certain PDCCH occasion 512, a PDCCH monitoring skipping may be started in cell 2 with a PDCCH skipping duration 514 configured by indication 510. Alternatively, When a PDCCH monitoring adaptation indication 510 is received in cell 2 at certain PDCCH occasion 512, a PDCCH monitoring skipping may be started in cell 2 with a PDCCH skipping duration 514 configured by indication 510. When a PDCCH monitoring adaptation indication 516 is received in cell 1 at another PDCCH occasion 512, and early termination 518 of skipping by indication 516 is performed on cell 2, the UE may resume the PDCCH monitoring in cell 2.

Although the UE is indicated with a skipping time duration, the skipping can also be early terminated by gNB indication. This is beneficial for the case that the traffic packet is arrived earlier than the predicted time. To enable the early termination and save the overhead, the following implicit methods can be used for the DCI filed for PDCCH monitoring adaptation.

In an example, when a PDCCH monitoring skipping is activated and not ended for cell 2, the PDCCH monitoring on cell 2 may be resumed (or the skipping is early terminated) based on determining that a value for the field of the DCI 1 is same as a value for the field of the DCI 2. In other words, the field of DCI 2 indicates a same behavior as the ongoing PDCCH monitoring skipping.

In another example, when a PDCCH monitoring skipping is activated and not ended for the first cell, the resuming is based on determining that the field of the DCI 2 indicates an invalid behavior. For example, the field of DCI 2 may indicate a specific behavior which is different from the ongoing PDCCH monitoring skipping, e.g., a SSSG switching. The field of DCI 2 may indicate “no PDCCH skipping”, which is already specified in existing NR standard.

In yet another example, when a PDCCH monitoring skipping is activated and not ended for the first cell, the resuming is based on determining that the value for the field of the DCI 2 equals to a reserved or preconfigured value.

When the PDCCH monitoring on cell 2 is determined to be resumed as shown in FIGS. 5a and 5b, the resuming may be implemented according to a specific SSSG. In some embodiments, the terminal device 110 may resume the PDCCH monitoring based on the SSSG which was used by the terminal device 110 before a PDCCH monitoring skipping for the cell 2 is activated. In other words, the terminal device 110 may resume the PDCCH monitoring based on the most recently used SSSG. In some embodiments, the terminal device 110 may resume the PDCCH monitoring based on a default or a preconfigured SSSG.

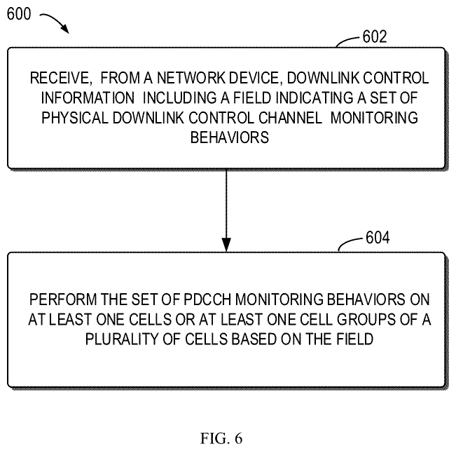

FIG. 6 illustrates an example method 600 of communication implemented at a network device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 602, the terminal device 110 receives, from the network device 120, DCI including a field indicating a set of PDCCH monitoring behaviors. The field includes one of the following: a plurality of bit sub-groups for a plurality of cells, or a bit group applied to the plurality of cells. At block 604, the terminal device 110 performs the set of PDCCH monitoring behaviors on at least one cells or at least one cell groups of the plurality of cells based on the field. With the method of FIG. 6, a scheme for improved multi-cell PDCCH monitoring adaptation is provided to enhance the flexibility of PDCCH monitoring, i.e., the PDCCH monitoring behavior can be adjusted in a per-cell manner, therefore power saving effect may be enhanced.

In some embodiments, a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the at least one cells comprises the first cell and the second cell, the at least one cell groups comprises the first cell group and the second cell group.

In some embodiments, a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the at least one cells comprises the third cell and the fourth cell, the at least one cell groups comprises the third cell group and the fourth cell group.

In some embodiments, the DCI further includes a carrier indication field. And the terminal device 110 may determine the at least one cells or the at least one cell groups based on the carrier indication field.

In some embodiments, the terminal device 110 may further determine the at least one cells or the at least one cell groups based on the difference between a preconfigured value and a received value for the bit group or a value for a bit sub-group. In some embodiments, the terminal device 110 may further determine the at least one cells or the at least one cell groups based on a row of a table associated with the bit group.

In some embodiments, the set of PDCCH monitoring behaviors includes at least one of: no PDCCH skipping and/or no PDCCH switching; skipping PDCCH monitoring for a duration: starting PDCCH monitoring with a first search space set group (SSSG) index, and stopping PDCCH monitoring with a second SSSG index; skipping PDCCH monitoring without indicating a duration; and terminating a PDCCH monitoring skipping.

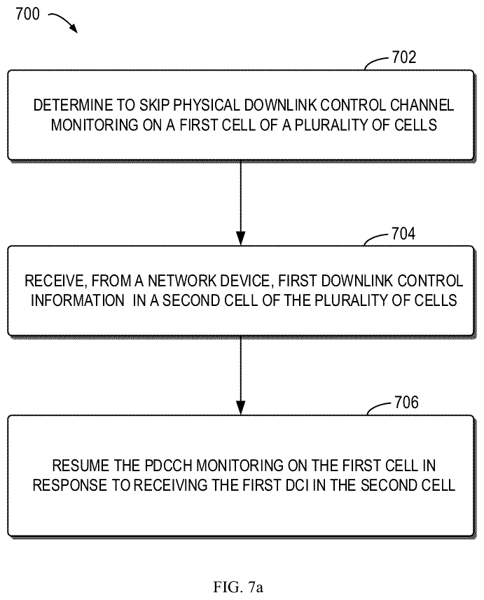

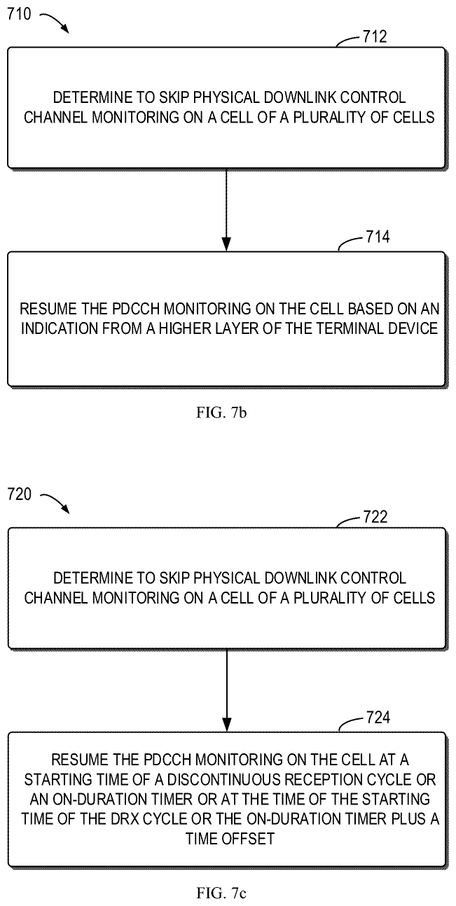

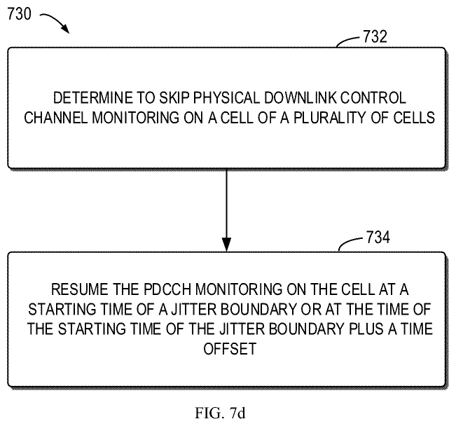

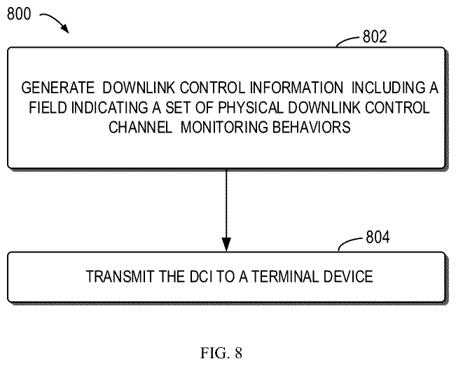

FIG. 7a illustrates another example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 702, the terminal device 110 determines to skip PDCCH monitoring on a first cell of a plurality of cells. At block 704, the terminal device 110 receives, from a network device, first DCI in a second cell of the plurality of cells. At block 706, the terminal device 110 resumes the PDCCH monitoring on the first cell in response to receiving the first DCI in the second cell. With the method of FIG. 7a, the PDCCH monitoring can be resumed as early as possible before the new packet arrived or can be resumed as desired for specific application. UE can stay in sleeping mode before it received the indication, therefore more power may be saved.

In some embodiments, the terminal device 110 may determine to skip the PDCCH monitoring by: receiving, from a network device, an indication of skipping PDCCH monitoring without indicating a duration; and determining to skip the PDCCH monitoring based on the indication.

In some embodiments, the terminal device 110 may further receive, from a network device, second DCI. The resuming may be based on determining that a value for the field of the first DCI is same as a value for the field of the second DCI.

In some embodiments, when a PDCCH monitoring skipping is activated and not ended for the first cell, the resuming may be based on at least one of the following: the field of the first DCI indicating an invalid behavior: or the field of the first DCI being equal to a preconfigured value.

In some embodiments, the terminal device 110 may resume the PDCCH monitoring on the first cell by resuming the PDCCH monitoring on the first cell based on the SSSG which was used by the terminal device before a PDCCH monitoring skipping for the first cell is activated. In some embodiments, the terminal device 110 may resume the PDCCH monitoring on the first cell by resuming the PDCCH monitoring on the first cell based on a default or a preconfigured SSSG.

FIG. 7b illustrates another example method 710 of communication implemented at a terminal device in accordance with some embodiments of the present disclosure. For example, the method 710 may be performed at the terminal device 110 as shown in FIG. 1. For the purpose of discussion, in the following, the method 710 will be described with reference to FIG. 1. It is to be understood that the method 710 may include additional blocks not shown and/or may omit some blocks as shown, and the scope of the present disclosure is not limited in this regard.

At block 712, the terminal device 110 determines to skip PDCCH monitoring on a cell of a plurality of cells. At block 714, the terminal device 110 resumes the PDCCH monitoring on the cell based on an indication from a higher layer of the terminal device. With the method of FIG. 7b, the PDCCH monitoring can be resumed as early as possible before the new packet arrived or can be resumed as desired for specific application. UE can stay in sleeping mode before it received the indication, therefore more power may be saved.

FIG. 7c illustrates another example method 720 of communication implemented at a terminal device in accordance with some embodiments of the present disclosure. For example, the method 720 may be performed at the terminal device 110 as shown in FIG. 1. For the purpose of discussion, in the following, the method 720 will be described with reference to FIG. 1. It is to be understood that the method 720 may include additional blocks not shown and/or may omit some blocks as shown, and the scope of the present disclosure is not limited in this regard.

At block 722, the terminal device 110 determines to skip PDCCH monitoring on a cell of a plurality of cells. At block 724, the terminal device 110 resumes the PDCCH monitoring on the cell at a starting time of a DRX cycle or an on-duration timer or at the time of the starting time of the DRX cycle or the on-duration timer plus a time offset. With the method of FIG. 7c, the PDCCH monitoring can be resumed as early as possible before the new packet arrived or can be resumed as desired for specific application. UE can stay in sleeping mode before an event occurs, therefore more power may be saved.

FIG. 7d illustrates another example method 730 of communication implemented at a terminal device in accordance with some embodiments of the present disclosure. For example, the method 730 may be performed at the terminal device 110 as shown in FIG. 1. For the purpose of discussion, in the following, the method 730 will be described with reference to FIG. 1. It is to be understood that the method 730 may include additional blocks not shown and/or may omit some blocks as shown, and the scope of the present disclosure is not limited in this regard.

At block 732, the terminal device 110 determines to skip PDCCH monitoring on a cell of a plurality of cells. At block 734 the terminal device 110 resumes the PDCCH monitoring on the cell at a starting time of a jitter boundary or at the time of the starting time of the jitter boundary plus a time offset. In some embodiments, the starting time of the jitter boundary is an earliest time that a traffic packet is expected to arrive at the terminal device. With the method of FIG. 7d, the PDCCH monitoring can be resumed as early as possible before the new packet arrived or can be resumed as desired for specific application. UE can stay in sleeping mode before a condition is met, therefore more power may be saved.

FIG. 8 illustrates an example method 800 of communication implemented at a network device in accordance with some embodiments of the present disclosure. For example, the method 800 may be performed at the network device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 802, the network device 120 generates DCI including a field indicating a set of PDCCH monitoring behaviors. The field includes one of the following: a plurality of bit sub-groups for a plurality of cells, or a bit group applied to the plurality of cells. At block 804, the network device 120 transmits the DCI to a terminal device 110. With the method of FIG. 8, a scheme for improved multi-cell PDCCH monitoring adaptation is provided to enhance the flexibility of PDCCH monitoring, i.e., the PDCCH monitoring behavior can be adjusted in a per-cell manner, therefore power saving effect may be enhanced.

In some embodiments, a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the plurality of cells comprises the first cell and the second cell, or the plurality of cells comprises the first cell group and the second cell group.

In some embodiments, a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the plurality of cells comprises the third cell and the fourth cell, or the plurality of cells comprises the third cell group and the fourth cell group.

In some embodiments, the set of PDCCH monitoring behaviors includes at least one of: no PDCCH skipping and/or no PDCCH switching; skipping PDCCH monitoring for a duration; starting PDCCH monitoring with a first search space set group (SSSG) index, and stopping PDCCH monitoring with a second SSSG index; skipping PDCCH monitoring without indicating a duration; and terminating a PDCCH monitoring skipping.

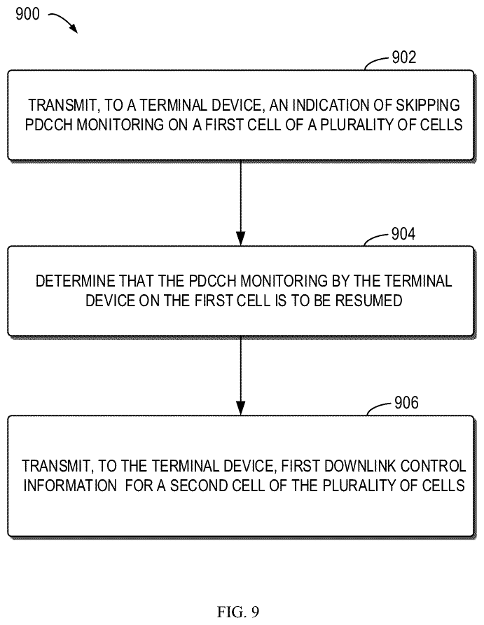

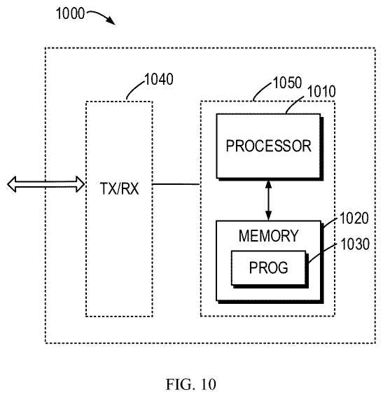

FIG. 9 illustrates another example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 902, the network device 120 transmits, to the terminal device 110, an indication of skipping PDCCH monitoring on a first cell of a plurality of cells. At block 904, the network device 120 determines that the PDCCH monitoring by the terminal device on the first cell is to be resumed. At block 906, the network device 120 transmits, to the terminal device 110, first DCI for a second cell of the plurality of cells. With the method of FIG. 9, the PDCCH monitoring can be resumed as early as possible before the new packet arrived or can be resumed as desired for specific application. UE can stay in sleeping mode before it received the indication, therefore more power may be saved.

In some embodiments, the network device 120 further transmits, to the terminal device 110, second DCI. The resuming is based on determining that a value for the field of the first DCI is same as a value for the field of the second DCI.

In some embodiments, when a PDCCH monitoring skipping is activated and not ended for the first cell, the resuming is based on at least one of the following: the field of the first DCI indicating an invalid behavior: or the field of the first DCI being equal to a preconfigured value.

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to perform method 600. In some embodiments, a terminal device comprises circuitry configured to perform method 700-730. In some embodiments, a network device comprises circuitry configured to perform method 800. In some embodiments, a network device comprises circuitry configured to perform method 900.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

In summary; embodiments of the present disclosure may provide the following solutions.

A method of communication comprises: receiving, at a terminal device from a network device, downlink control information (DCI) including a field indicating a set of physical downlink control channel (PDCCH) monitoring behaviors, the field including one of the following: a plurality of bit sub-groups for a plurality of cells, or a bit group applied to the plurality of cells; and performing the set of PDCCH monitoring behaviors on at least one cells or at least one cell groups of a plurality of cells based on the field.

In some embodiments, a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the at least one cells comprises the first cell and the second cell, the at least one cell groups comprises the first cell group and the second cell group.

In some embodiments, a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the at least one cells comprises the third cell and the fourth cell, the at least one cell groups comprises the third cell group and the fourth cell group.

In some embodiments, the DCI further includes a carrier indication field. And the method further comprises: determining, based on the carrier indication field, the at least one cells or the at least one cell groups.

In some embodiments, the method further comprising: determining, based on the difference between a preconfigured value and a received value for the bit group or a value for a bit sub-group, the at least one cells or the at least one cell groups.

In some embodiments, the method further comprising: determining, based on a row of a table associated with the bit group, the at least one cells or the at least one cell groups.

In some embodiments, the set of PDCCH monitoring behaviors includes at least one of: no PDCCH skipping and/or no PDCCH switching; skipping PDCCH monitoring for a duration; starting PDCCH monitoring with a first search space set group (SSSG) index, and stopping PDCCH monitoring with a second SSSG index; skipping PDCCH monitoring without indicating a duration; and terminating a PDCCH monitoring skipping.

A method of communication, comprising: determining, at a terminal device, to skip physical downlink control channel (PDCCH) monitoring on a first cell of a plurality of cells; receiving, from a network device, first downlink control information (DCI) in a second cell of the plurality of cells; and resuming the PDCCH monitoring on the first cell in response to receiving the first DCI in the second cell.

In some embodiments, determining to skip the PDCCH monitoring comprises: receiving, from the network device, an indication of skipping PDCCH monitoring without indicating a duration; and determining to skip the PDCCH monitoring based on the indication.

In some embodiments, the method further comprising: receiving, from the network device, second DCI, wherein the resuming is based on determining that a value for the field of the first DCI is same as a value for the field of the second DCI.

In some embodiments, when a PDCCH monitoring skipping is activated and not ended for the first cell, the resuming is based on at least one of the following: the field of the first DCI indicating an invalid behavior; or the field of the first DCI being equal to a preconfigured value.

In some embodiments, resuming the PDCCH monitoring on the first cell comprises: resuming the PDCCH monitoring based on the Search Space Set Group (SSSG) which was used by the terminal device before a PDCCH monitoring skipping for the first cell is activated.

In some embodiments, resuming the PDCCH monitoring on the first cell comprises: resuming the PDCCH monitoring based on a default or a preconfigured SSSG.

A method of communication, comprising: determining, at a terminal device, to skip physical downlink control channel (PDCCH) monitoring on a cell of a plurality of cells; and resuming the PDCCH monitoring on the cell based on an indication from a higher layer of the terminal device.

A method of communication, comprising: determining, at a terminal device, to skip physical downlink control channel (PDCCH) monitoring on a cell of a plurality of cells; and resuming the PDCCH monitoring on the cell at a starting time of a discontinuous reception (DRX) cycle or an on-duration timer or at the time of the starting time of the DRX cycle or the on-duration timer plus a time offset.

A method of communication, comprising: determining, at a terminal device, to skip physical downlink control channel (PDCCH) monitoring on a cell of a plurality of cells; and resuming the PDCCH monitoring on the cell at a starting time of a jitter boundary or at the time of the starting time of the jitter boundary plus a time offset.

In some embodiments, the starting time of the jitter boundary is an earliest time that a traffic packet is expected to arrive at the terminal device.

A method of communication, comprising: generating, at a network device, downlink control information (DCI) including a field indicating a set of physical downlink control channel (PDCCH) monitoring behaviors, the field including one of the following: a plurality of bit sub-groups for a plurality of cells, or a bit group applied to the plurality of cells; and transmitting the DCI to a terminal device.

In some embodiments, a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the plurality of cells comprises the first cell and the second cell, or the plurality of cells comprises the first cell group and the second cell group.

In some embodiments, a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the plurality of cells comprises the third cell and the fourth cell, or the plurality of cells comprises the third cell group and the fourth cell group.

In some embodiments, the set of PDCCH monitoring behaviors includes at least one of: no PDCCH skipping and/or no PDCCH switching: skipping PDCCH monitoring for a duration: starting PDCCH monitoring with a first search space set group (SSSG) index, and stopping PDCCH monitoring with a second SSSG index: skipping PDCCH monitoring without indicating a duration; and terminating a PDCCH monitoring skipping.

A method of communication, comprising: transmitting, at a network device to a terminal device, an indication of skipping PDCCH monitoring on a first cell of a plurality of cells; determining that the PDCCH monitoring by the terminal device on the first cell is to be resumed; and transmitting, to the terminal device, first downlink control information (DCI) for a second cell of the plurality of cells.

In some embodiments, the method further comprising: transmitting, to the terminal device, second DCI, wherein the resuming is based on determining that a value for the field of the first DCI is same as a value for the field of the second DCI.

In some embodiments, when a PDCCH monitoring skipping is activated and not ended for the first cell, the resuming is based on at least one of the following: the field of the first DCI indicating an invalid behavior: or the field of the first DCI being equal to a preconfigured value.

A network device comprising: a processor; and a memory coupled to the processor and storing instructions thereon, the instructions, when executed by the processor, causing the network device to perform acts comprising the method according to any of the above embodiments.

A terminal device comprises: a processor; and a memory coupled to the processor and storing instructions thereon, the instructions, when executed by the processor, causing the terminal device to perform acts comprising the method according to any of the above embodiments.

A computer readable medium having instructions stored thereon, the instructions, when executed on at least one processor, causing the at least one processor to perform the method according to any of the above embodiments.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device from a network device, downlink control information (DCI) including a field indicating a set of physical downlink control channel (PDCCH) monitoring behaviors, the field including one of the following:
a plurality of bit sub-groups for a plurality of cells, or
a bit group applied to the plurality of cells; and
performing the set of PDCCH monitoring behaviors on at least one cells or at least one cell groups of the plurality of cells based on the field.

2. The method of claim 1, wherein a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the at least one cells comprises the first cell and the second cell, the at least one cell groups comprises the first cell group and the second cell group.

3. The method of claim 1, wherein a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the at least one cells comprises the third cell and the fourth cell, the at least one cell groups comprises the third cell group and the fourth cell group.

4. The method of claim 1, wherein the DCI further includes a carrier indication field and the method further comprises:
determining, based on the carrier indication field, the at least one cells or the at least one cell groups.

5. The method of claim 1, further comprising:
determining, based on the difference between a preconfigured value and a received value for the bit group or a value for a bit sub-group, the at least one cells or the at least one cell groups.

6. The method of claim 1, further comprising:
determining, based on a row of a table associated with the bit group, the at least one cells or the at least one cell groups.

7. The method of claim 1, wherein the set of PDCCH monitoring behaviors includes at least one of:
no PDCCH skipping and/or no PDCCH switching;
skipping PDCCH monitoring for a duration;
starting PDCCH monitoring with a first search space set group (SSSG) index, and stopping PDCCH monitoring with a second SSSG index;
skipping PDCCH monitoring without indicating a duration; and
terminating a PDCCH monitoring skipping.

8. A method of communication, comprising:
determining, at a terminal device, to skip physical downlink control channel (PDCCH) monitoring on a first cell of a plurality of cells;
receiving, from a network device, first downlink control information (DCI) in a second cell of the plurality of cells; and
resuming the PDCCH monitoring on the first cell in response to receiving the first DCI in the second cell.

9. The method of claim 8, wherein determining to skip the PDCCH monitoring comprises:
receiving, from the network device, an indication of skipping PDCCH monitoring without indicating a duration; and
determining to skip the PDCCH monitoring based on the indication.

10. The method of claim 8, further comprising:
receiving, from the network device, second DCI,
wherein the resuming is based on determining that a value for the field of the first DCI is same as a value for the field of the second DCI.

11. The method of claim 8, wherein when a PDCCH monitoring skipping is activated and not ended for the first cell, the resuming is based on at least one of the following:
the field of the first DCI indicating an invalid behavior; or
the field of the first DCI being equal to a preconfigured value.

12. The method of claim 8, wherein resuming the PDCCH monitoring on the first cell comprises:
resuming the PDCCH monitoring based on the Search Space Set Group (SSSG) which was used by the terminal device before a PDCCH monitoring skipping for the first cell is activated.

13. The method of claim 8, wherein resuming the PDCCH monitoring on the first cell comprises:
resuming the PDCCH monitoring based on a default or a preconfigured SSSG.

14-24. (canceled)

25. A terminal device comprising:
a processor; and
a memory storing computer program codes;
the memory and the computer program codes configured to, with the processor, cause the terminal device to: receive, at the terminal device from a network device, downlink control information (DCI) including a field indicating a set of physical downlink control channel (PDCCH) monitoring behaviors, the field including one of the following: a plurality of bit sub-groups for a plurality of cells, or a bit group applied to the plurality of cells; and perform the set of PDCCH monitoring behaviors on at least one cells or at least one cell groups of the plurality of cells based on the field.

26-27. (canceled)

28. The terminal device of claim 25, wherein a first value for the bit group indicates a first PDCCH monitoring behavior for a first cell or a first cell group, and the first value indicates a second PDCCH monitoring behavior for a second cell or a second cell group, wherein the set of PDCCH monitoring behaviors comprises the first PDCCH monitoring behavior and the second PDCCH monitoring behavior, the at least one cells comprises the first cell and the second cell, the at least one cell groups comprises the first cell group and the second cell group.

29. The terminal device of claim 25, wherein a second value for a first bit sub-group indicates a third PDCCH monitoring behavior for a third cell or a third cell group, and a third value for a second bit sub-group indicates a fourth PDCCH monitoring behavior for a fourth cell or a fourth cell group, wherein the plurality of bit sub-groups comprises the first bit sub-group and the second bit sub-group, the set of PDCCH monitoring behaviors comprises the third PDCCH monitoring behavior and the fourth PDCCH monitoring behavior, the at least one cells comprises the third cell and the fourth cell, the at least one cell groups comprises the third cell group and the fourth cell group.

30. The terminal device of claim 25, wherein the DCI further includes a carrier indication field and the terminal device is further caused to:
determine, based on the carrier indication field, the at least one cells or the at least one cell groups.

31. The terminal device of claim 25, further comprising:
determine, based on the difference between a preconfigured value and a received value for the bit group or a value for a bit sub-group, the at least one cells or the at least one cell groups.

32. The terminal device of claim 25, further comprising:
determine, based on a row of a table associated with the bit group, the at least one cells or the at least one cell groups.

33. The terminal device of claim 25, wherein the set of PDCCH monitoring behaviors includes at least one of:
no PDCCH skipping and/or no PDCCH switching;
skipping PDCCH monitoring for a duration;
starting PDCCH monitoring with a first search space set group (SSSG) index, and stopping PDCCH monitoring with a second SSSG index;
skipping PDCCH monitoring without indicating a duration; and
terminating a PDCCH monitoring skipping.
